(19) United States
(12) Patent Application Publication
(10) Pub. No.: US 2008/0054102 A1
(43) Pub. Date: Mar. 6, 2008

(54) Head for a precision ceramic gas cooker

(76) Inventor: Yuan Fu Chang, Fongyuan City (TW)

Correspondence Address: CHARLES E. BAXLEY, ESQ., 90 JOHN STREET, THIRD FLOOR, NEW YORK, NY, 10038, US

(21) Appl. No.: 11/512,010

(22) Filed: Aug. 29, 2006

(51) Int. Cl. B05B 1/14

(52) U.S. Cl. 239/559; 239/567

(57) ABSTRACT

A head for a precision ceramic gas cooker comprises a seat, a cover assembly and a mixing tube. The seat, the cover assembly and the mixing tube are made of precision ceramic which has the high temperature resisting property, and are coated with enamel on the surfaces thereof so as to provide variety of colors and patterns of the head, thus solving the conventional problem of unable to change the colors and patterns of the metal materials.

### BACKGROUND OF THE INVENTION

1. Field of the Invention

The present invention relates to a gas cooker, and more particularly to a head for a precision ceramic gas cooker.

2. Description of the Prior Art

A conventional head for a gas cooker comprises a seat which is covered with an inner annular cover and an outer annular cover, and the inner and outer annular covers are made of pure copper or cast iron which has the property of heat-resisting (700° C.). However, the colors of those metals are single, so that the manufactured cover only has the same color as that of the metal, and the cover cannot be covered with other colors, which is very monotonous.

The present invention has arisen to mitigate and/or obviate the afore-described disadvantages.

### SUMMARY OF THE INVENTION

The primary objective of the present invention is to provide a head for a precision ceramic gas cooker which is coated with enamel so as to provide variety of colors.

The secondary objective of the present invention is to provide a head for a precision ceramic gas cooker comprises a seat, a cover assembly and a mixing tube. The seat, the cover assembly and the mixing tube are made of precision ceramic, and the cover assembly is covered on the seat.

The seat, the cover assembly and the mixing tube of the above-mentioned head for a precision ceramic gas cooker are made of precision ceramic which have the high temperature resisting property, and are coated with enamel on the surfaces thereof so as to provide variety of colors and patterns of the head, thus solving the conventional problem of unable to change the colors and patterns of the metal materials.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a head for a precision ceramic gas cooker in accordance with the present invention;

FIG. 2 is an exploded view of the head for a precision ceramic gas cooker in accordance with the present invention; and

FIG. 3 is a cross sectional view of the head for a precision ceramic gas cooker in accordance with the present invention;

### DETAILED DESCRIPTION OF THE PREFERRED EMBODIMENTS

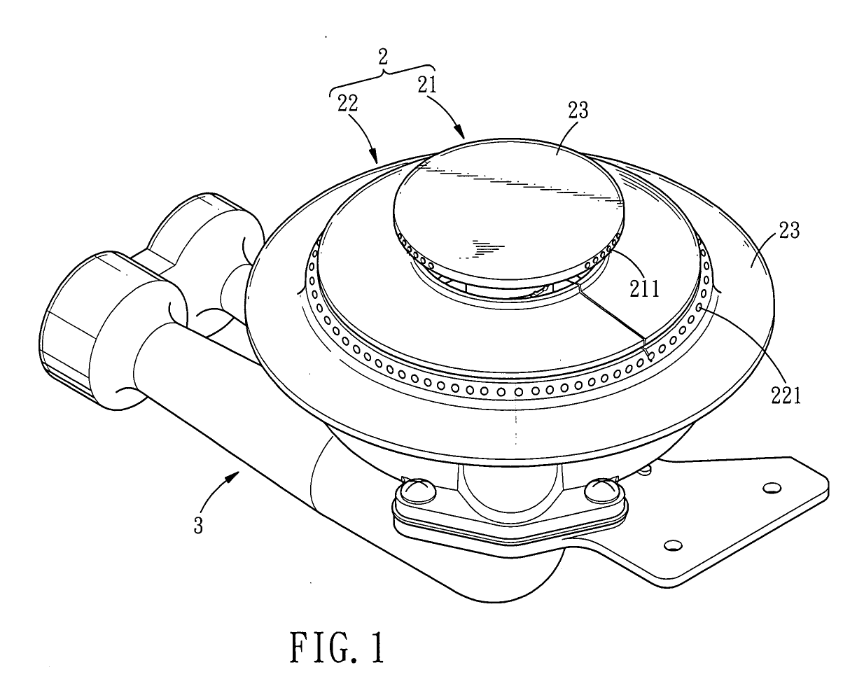

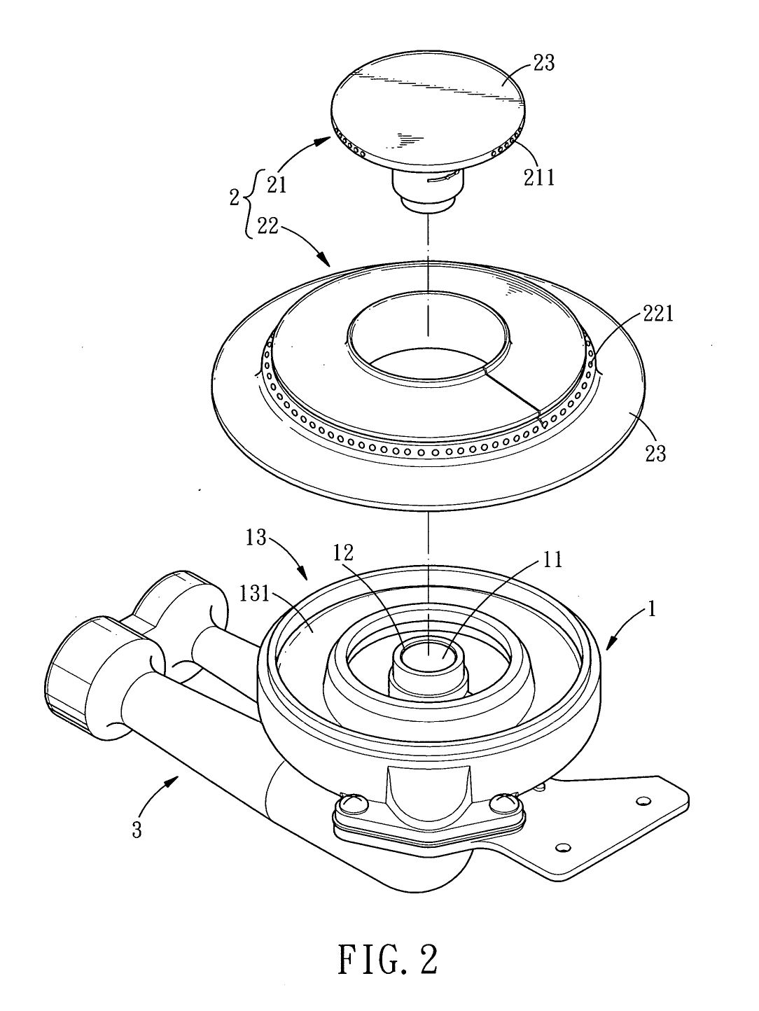

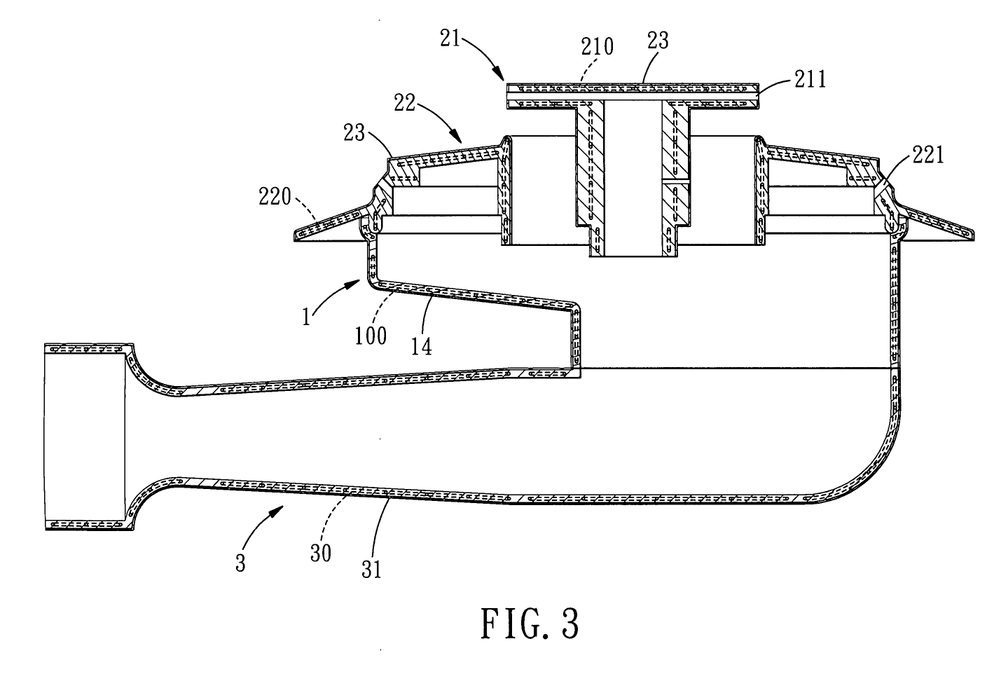

Referring to FIGS. 1-3, wherein FIG. 1 is a perspective view of a head for a precision ceramic gas cooker, FIG. 2 is an exploded view of the head for a precision ceramic gas cooker, and FIG. 3 is a cross sectional view of the head for a precision ceramic gas cooker.

The head for a precision ceramic gas cooker in accordance with the present invention comprises a seat 1 which is disposed on a mixing tube 3, and a cover assembly 2 is coated on the seat 1.

The seat 1 is made of precision ceramic, a metal frame 100 is provided for supporting the seat 1, the surface of the seat 1 is coated with enamel 14, and in the center of the seat 1 is formed a through hole 11, through which the seat 1 is mounted on the mixing tube 3. The mixing tube 3 is made of precision ceramic, a metal frame 30 is provided for supporting the mixing tube 3 and for supplying gas to the head. The surface of the mixing tube 3 is coated with enamel 31 so as to change the color and pattern of the surface. Annularly arranged around the through hole 11 of the seat 11 is an inner annular cover frame 12, and in a predetermined position of the inner annular cover frame 12 is annularly disposed an outer annular cover frame 13. The outer annular cover frame 13 is defined with a groove 131, and the groove 131 is connected to the mixing tube 3.

The cover assembly 2 includes an inner annular cover 21 and an outer annular cover 22. The inner annular cover 21 is supported by a metal frame 210, which is made of precision ceramic so as to strengthen the structure of the inner annular cover 21. The inner annular cover 21 is covered with enamel 23 so as to provide a variety of colors and patterns. The inner annular cover 21 is covered on the inner annular cover frame 12 of the seat 1, and a plurality of holes 211 is formed in the surface of the inner annular cover 21 and is provided for passage of the gas.

The outer annular cover 22 is supported by a metal frame 220, which is made of precision ceramic so as to strengthen the structure of the outer annular cover 22. The outer annular cover 22 is covered with enamel 23 so as to provide variety of colors and patterns. The outer annular cover 22 is covered on the outer annular cover frame 13 of the seat 1, and a plurality of holes 221 is formed in the surface of the outer annular cover 22 and is provided for dissipation of the gas.

The seat 1, the cover assembly 2 and the mixing tube 3 of the above-mentioned head for a precision ceramic gas cooker are made of precision ceramic which have the high temperature resisting property (about 1400° C.), and are coated with enamel on the surfaces thereof so as to provide variety of colors and patterns of the head, thus solving the conventional problem of unable to change the colors and patterns of the metal materials.

While we have shown and described various embodiments in accordance with the present invention, it should be clear to those skilled in the art that further embodiments may be made without departing from the scope of the present invention.

What is claimed is:

1. A head for a precision ceramic gas cooker comprising: a seat, a cover assembly and a mixing tube, the seat being disposed on the mixing tube, and the cover assembly being covered on the seat, wherein:
the seat, the cover assembly and the mixing tube are made of precision ceramic.

2. The head for a precision ceramic gas cooker as claimed in claim 1, wherein the seat, the cover assembly and the mixing tube are supported by metal frames so as to strengthen structures of the seat, the cover assembly and the mixing tube.

3. The head for a precision ceramic gas cooker as claimed in claim 1, wherein the cover assembly includes an inner annular cover and an outer annular cover.

4. The head for a precision ceramic gas cooker as claimed in claim 1, wherein the seat, the cover assembly and the mixing tube are coated with enamel on the surfaces thereof so as to provide a variety of colors and patterns.
